(19) United States
(12) Patent Application Publication
(10) Pub. No.: US 2011/0101653 A1
(43) Pub. Date: May 5, 2011

(54) PASSENGER PROTECTION DEVICE FOR A VEHICLE

(75) Inventors: Ulrich RICK, Braunweiler (DE); Thomas JENNY, Alsbach-Haehnlein (DE)

(73) Assignee: GM GLOBAL TECHNOLOGY OPERATIONS, INC., Detroit, MI (US)

(21) Appl. No.: 12/883,792

(22) Filed: Sep. 16, 2010

(30) Foreign Application Priority Data
Sep. 16, 2009 (DE) 102009041711.7

(51) Int. Cl. B60R 21/20; B23P 11/00

(52) U.S. Cl. 280/728.3; 29/428

(57) ABSTRACT

A passenger protection device is provided for a vehicle, with an airbag module. The airbag module encompasses an airbag module cover, which has a weakened area. The weakened area is suitable and/or designed for providing an opening function of the airbag module given an activation of the airbag module. The airbag module has a covering, with one edge area of the covering being aligned to following the progression of the weakened area.

### CROSS-REFERENCE TO RELATED APPLICATION

This application claims priority to German Patent Application No. 102009041711.7, filed Sep. 16, 2009, which is incorporated herein by reference in its entirety.

### TECHNICAL FIELD

The invention relates to a passenger protection device for a vehicle with an airbag module, wherein the airbag module encompasses an airbag module cover with a weakened area, wherein the weakened area is suitable and/or designed to provide an opening function for the airbag module upon activation of the airbag module, and wherein the airbag module has a covering.

### BACKGROUND

Passenger protection devices are usually integrated into a vehicle for protecting passengers. As a rule, passenger protection devices have one or more airbag modules, which encompass an airbag module cover, an airbag, and a gas generator. If the airbag module is activated, e.g., by an accident, gas streams out of the gas generator into the airbag. The airbag inflates and passes through a weakened area, which is usually situated on the airbag module cover, exiting the airbag module. Airbag modules with leather, fabric or plastic covering are sufficiently known.

Publication DE 102 31 131 likely represents the most obvious prior art, and discloses an airbag cover and method for manufacturing an airbag cover. The airbag cover has a first layer and a second layer. The first layer is essentially undamaged in the area of a tearing seam for deploying an airbag, and borders the space into which the airbag deploys when needed. The second layer is integrated on the rear side of the first layer to strengthen it, wherein only the second layer has a weakened area to guide the progression of the tearing seam during airbag deployment.

At least one object of the invention is to make a passenger protection device function and/or design oriented. In addition, other objects, desirable features, and characteristics will become apparent from the subsequent summary and detailed description, and the appended claims, taken in conjunction with the accompanying drawings and this background.

### SUMMARY

The embodiments of the invention propose a passenger protection device that is suitable and/or designed for integration into a vehicle, in particular a car. The passenger protection device encompasses an airbag module having an airbag module cover. The airbag module is preferably arranged in a hub area of a steering wheel, and designed as a front driver's side airbag, in particular as a ring airbag. In particular, the airbag module has at least one gas generator and at least one airbag, which is designed to deploy in the direction of the driver of a vehicle during an accident.

The airbag module cover has a weakened area, wherein the weakened area is suitable and/or designed for providing an opening function of the airbag module given an activation of the airbag module. The weakened area is preferably designed as a weakened line. In particular, the airbag module cover opens in the weakened area when partial areas of the airbag module cover are folded open and/or over, for example. The airbag module cover usually tears open in the weakened area during the accident, thereby allowing the airbag to completely deploy in the direction of the driver of the vehicle. As an option, the weakened area or weakened line is designed to run straight, curved and/or circularly and/or take another suitable linear progression. It is especially preferred that the weakened area be designed as a tear-open seam and/or a predetermined breaking point.

In addition, the airbag module has a covering. In particular, the covering consists of a textile fabric having a significantly smaller thickness relative to its length. The covering is preferably applied to the airbag module and/or covers the airbag module. The covering optionally covers the airbag module entirely or partially. As an option, the covering has a flexible design.

According to an embodiment of the invention, an edge area of the covering is aligned and/or arranged to follow the same progression as the weakened area. The edge area of the covering preferably runs along the weakened area, with the edge area of the covering in particular running parallel and/or congruent to the weakened area. Specifically, the covering does not span the weakened area. The edge area preferably runs over at least approximately 70%, preferably over at least approximately 80%, and in particular over at least approximately 90% of the length spanned by the weakened area, in particular the weakened line. Alternatively or additionally, it is preferred that the edge area run over at least approximately 10 cm, in particular over at least approximately 15 cm of the length spanned by the weakened area, in particular the weakened line.

The advantage to the invention is that, because the progression of the edge area is aligned with that of the weakened area, functional and design elements can be simplified. The covering makes it possible to configure a visible surface of the airbag module cover accordingly and/or oriented to the design. At the same time, the function of the weakened area is not impaired, since the structural design of the covering according to the invention has little or no influence on an opening and/or tearing behavior of the weakened area.

In an especially preferred embodiment, the covering in the weakened area is optically abutted. Optical abutting is when the edge areas of two covering areas are adjacent and/or contact each other in an abutment area, wherein the abutment area is aligned and/or designed to follow the same progression of the weakened area, in particular the weakened line.

Another possible embodiment of the invention provides that the weakened area be situated exclusively on a bottom side of the airbag module cover, wherein the bottom side is a side of the airbag module cover arranged in a direction facing the airbag module and away from the driver of the vehicle. In particular, the weakened area is not situated so that it can be seen or felt by the driver of the vehicle. The visible surface of the airbag module cover is advantageously not impaired.

In another preferred embodiment of the invention, the covering encompasses a textile as the decorative material. The textile can be a textile fabric having fibers and/or yarns, which can take the form of woven, knitted and/or crocheted fabrics. It is possible for the textile to encompass a material, cloth, felt and/or fleece. The textile preferably has natural constituents, e.g., natural and/or plant fibers and/or animal fibers. As an option, the textile has artificial constituents, e.g., plastic and/or chemical fibers. The textile specifically encompasses polyester, polyamide, cotton and/or viscose fibers.

In another possible embodiment, the covering encompasses leather and/or pelt. The material can here be genuine leather and/or genuine animal pelt. However, it is also conceivable for the covering to be comprised of artificial leather and/or artificial pelt.

Another possible embodiment of the invention provides that the covering encompasses a film. The film is preferably at least partially made of a plastic or metal. In particular, the film has a thickness of up to approximately 2.5 mm, in particular of up to approximately 1.5 mm, especially of up to approximately 0.5 mm.

It is understood that combinations of the aforementioned covering variants, specifically textile, leather, pelt or film, are possible for the airbag module. For example, only the textile or leather or pelt or film can cover the airbag module. However, it is also possible for the airbag module to be covered by a pelt, and the airbag module cover with a textile, for example. It is also conceivable that the airbag module is covered with leather, and the airbag module cover has a film as the covering. In like manner, it is conceivable that partial areas of the airbag module have no covering, while other areas of the airbag module are covered by a covering. The partial areas of the airbag module without a covering can here have a dyed material or coating of paint, for example. Combinations of all aforementioned variants are also possible.

In another embodiment according to the invention, the covering is continuously formed inside and/or between and/or on the edge areas in terms of its surface and/or expansion. The covering inside and/or between and/or on the edge areas preferably has no interruptions and/or recesses.

In another possible embodiment, the covering inside and/or between and/or on the edge areas has holes in terms of its surface and/or expansion, in particular having a grid design and/or some other suitable pattern. It is also conceivable for the covering to be designed as an emblem, symbol, character and/or logo.

In another possible embodiment of the invention, the covering is optically or haptically adjusted and/or tailored and/or designed identically to other coverings of a vehicle passenger compartment and/or to the configuration of a sheet metal apron of the vehicle. As a result, the invention can also relate to a passenger compartment with the passenger protection device. The vehicle passenger compartment usually encompasses equipment elements, e.g., interior door panels, seat covers, an instrument panel, general cladding parts, and many others. The covering preferably has similar and/or identical patterns, colors, surface structures, etc. as the equipment elements and/or sheet metal apron. In particular, the covering can have an identical pattern and different color than the equipment elements, or the same color and another pattern, for example. As an option, the covering can have symbols, for example form a marketing campaign, which are also situated on and/or at the equipment elements of the vehicle passenger compartment and/or on the sheet metal apron of the vehicle.

In another possible embodiment of the invention, the passenger protection device, in particular the airbag module, has at least one structural arrangement for accommodating the edge area and/or screening the edge area. In many preferred embodiments, the structural arrangement has a length of at least approximately 5 mm, preferably of at least approximately 15 mm, in particular of at least approximately 30 mm, and especially of at least approximately 50 mm.

The structural arrangement makes it possible in an advantageous manner to avoid and/or prevent the edge area from becoming detached and/or frayed. This is especially advantageous, since the covering usually is continuously in contact with the driver, and so can become abraded and/or worn more easily and/or rapidly. In addition, a detachment of the covering can be effectively countered. It is further advantageous that tolerances can be offset when positioning a covering relative to the carrier material, and when cutting a covering to size.

In a preferred embodiment, the structural arrangement is designed as a bead and/or groove, the depression of which accommodates the edge area. Another possible configuration of the structural arrangement involves a wrapping and/or bending of the edge area around a carrier material of the airbag module cover. It is also conceivable that the structural arrangement be designed as a roofing and/or enclosure of the edge area. As an option, a shoulder can be provided as the structural arrangement between the carrier material of the airbag module cover and the edge area.

In another possible embodiment of the invention the covering designed as one of the above covering variants has one or more intermediate alleys. For example, the intermediate layer can be an adhesive material, such as glue and/or wax. However, the intermediate layer can also be designed as a carrier layer and/or carrier film, e.g., a barrier layer or composite material, which is secured to the covering in a suitable attachment process, e.g., adhesive bonding.

In another possible embodiment, the covering designed as one of the above covering variants is joined in a flush manner with the airbag module. It is possible that the intermediate layer is suitable and/or designed for joining the covering with the airbag module in a flush manner. For example, the intermediate layer designed as a carrier layer and/or film of the covering can be joined with the airbag module through back injection molding. As an option, the covering and airbag module are joined through gluing and/or laminating. It is also conceivable that joining take place via thermal heat supply, in particular by means of welding and/or lasers. In another possible embodiment, the covering is applied to the airbag module and/or joined with the latter without an intermediate layer.

It is advantageous that the cover be secured onto the airbag module in a safe and sufficiently tight manner in the flush joining process. This makes it possible to avoid an undesired detachment of the covering.

In another possible embodiment of the invention, a tear area of the covering covers the weakened area entirely or partially. The tear area is preferably completely homogenous over the entire weakened area in the transverse extension. In particular, the tear area extends perpendicular and/or along the progression and/or parallel to the progression of the weakened area, wherein the tear area is continuously homogenous in design over the entire weakened area at the transition. In particular, the tear area has no additional weakening and/or perforation and/or predetermined breaking point(s). It is especially preferred that the tear area have the same thickness and/or gauge over its entire surface and/or expansion. For example, the tear area extends over approximately 50%, in particular over approximately 80%, of the weakened area.

As disclosed in Publications DE 102 60 988 Al and DE 102 31 131 A1, textile layers and/or sheet-like fabrics designed to be applied to an airbag module usually have tear areas with weakened zones, e.g., introduced via mechanical processing. The manufacturing step in which the weakened zones are introduced into the fiber material is advantageously eliminated. Another advantage of note is that the covering that covers the airbag module cover and the weakened area has no visible opening and/or tear area, because of which it can be integrated into the vehicle passenger compartment, in particular into the steering wheel, in a design-oriented manner. This makes it possible to combine functional and design elements.

In a preferred embodiment, the covering is made out of a textile, in particular a fiber material, for example encompassing natural and/or plant fibers and/or animal fibers and/or artificial and/or chemical fibers. The fiber material is preferably suitable and/or designed for use in forming a textile fabric. In particular, the textile fabric is not woven. The textile fabric specifically is not comprised of woven and/or knitted and/or crocheted fabric. The advantage to such non-woven and/or non-knitted and/or non-crocheted textile fabrics is that they are suitable and/or designed to tear given an activation of the airbag module without preceding and/or additional weakening, in particular in the tear area. In a particularly preferred embodiment of the invention, the fiber material encompasses fleece and/or felt and/or flock.

In another possible embodiment of the invention the covering designed as one of the above covering variants has one or more surface-finishing elements. The surface-finishing element can be arranged in the covering or on a visible surface of the covering. The surface-finishing element preferably encompasses one or more embossed areas. In particular, the embossing process imparts a three dimensional structure to the covering. In one possible embodiment, the surface-finishing element can encompass a patch and/or sticker. As an option, the surface-finishing element is designed as an ornament and/or decoration.

In addition, it is possible for the surface-finishing element to be stitched and/or woven and/or crocheted in. Contrasting fibers can here be used, e.g., ones having a structure and/or color different than the covering. In another possible embodiment of the invention, the surface-finishing element can encompass filaments and/or luminescent elements, e.g., luminescent fibers, patches and/or stickers. As an option, the elements are phosphorescent and/or fluorescent in design, and/or exhibit phosphorescent and/or fluorescent constituents, e.g., dyes, films and/or coatings.

In another possible embodiment, the surface-finishing element can take the form of an imprinted area on the covering.

It is especially preferred that the surface-finishing elements be designed as a symbol, image, character, emblem and/or logo. In this way, for example, the surface-finishing element can take the form of a horn symbol and/or an airbag logo and/or a trademark.

The advantage to this aspect of the invention is that the surface-finishing element can configure the covering of the airbag in a design-oriented manner, while simultaneously serving as an information carrier. Therefore, it is possible in many cases to combine functions. The use of one or more surface-finishing elements, e.g., ones designed as a trademark or horn symbol, makes it possible to forego the use of additional information carriers. This can lead to a reduction in component number, and hence a cost savings. In addition, the covering can potentially be individually designed with surface-finishing elements. This makes it possible to satisfy customer wishes, thereby maintaining competitive advantages.

In another embodiment of the invention, the covering designed as one of the above covering variants has a protective layer. The protective layer is preferably arranged on the upper side of the covering, wherein the upper side forms the visible surface of the airbag nodule. In particular, the protective layer is formed via impregnation and/or a Teflon, Nano, Top Tec, and/or paint coating. The protective layer can be sprayed, daubed, or brushed on, or applied to the covering using any other suitable method. The protective layer is preferably suitable and/or designed to ensure an easy and effective cleaning of the covering. As a result, the protective layer can be advantageously offer protection against contamination, wear and/or yellowing. This makes it possible to ensure the long life of the covering, while maintaining the attractive optical appearance.

The subject matter of the invention also relates to a method for manufacturing and/or coating an airbag module, preferably for manufacturing the passenger protection device. The method encompasses coating the covering designed as one of the above covering variants with one or more intermediate layers. For example, the intermediate layer can be an adhesive material, such as glue and/or wax. However, the intermediate layer can also encompass a carrier layer and/or a carrier film, e.g., a barrier layer or composite material. The intermediate layer is advantageously secured to the covering in a suitable attachment process, e.g., adhesive bonding.

The method further encompasses a flush joining of the covering designed as one of the above covering variants with the airbag module. As an option, the covering and airbag module are joined via back injection molding and/or gluing and/or laminating. It is also conceivable that joining take place via thermal heat supply, in particular by means of welding and/or lasers.

### BRIEF DESCRIPTION OF THE DRAWINGS

The present invention will hereinafter be described in conjunction with the following drawing figures, wherein like numerals denote like elements, and:

FIG. 1 is a top view of a steering wheel with a passenger protection device;

FIG. 2 is a section through a variant of the passenger protection device from FIG. 1; and

FIG. 3 is a section through another modification of the passenger protection device from FIG. 1

### DETAILED DESCRIPTION

The following detailed description is merely exemplary in nature and is not intended to application and uses. Furthermore, there is no intention to be bound by any theory presented in the preceding background or summary or the following detailed description.

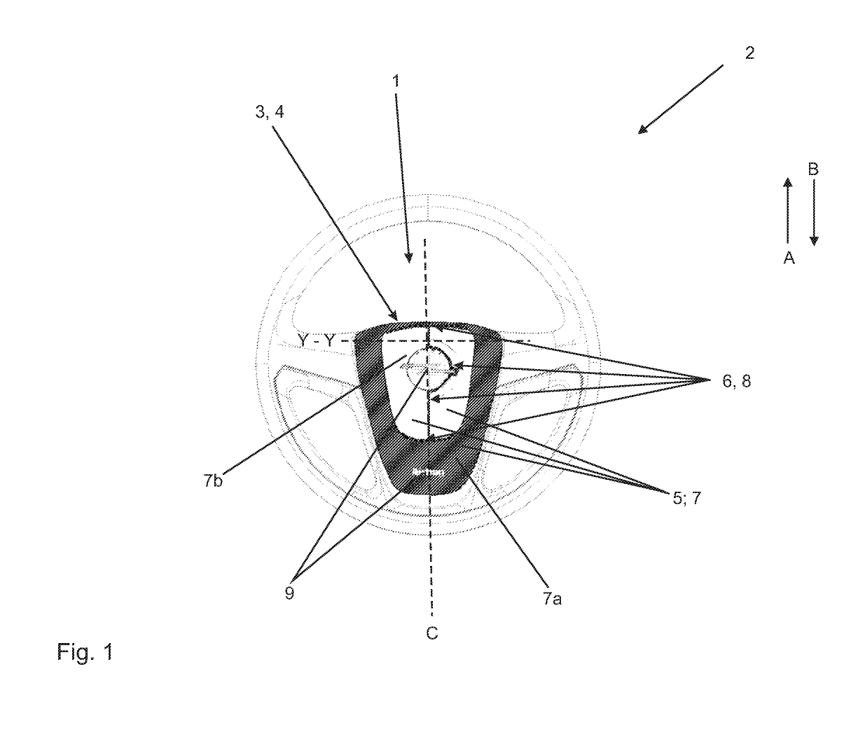

One possible exemplary embodiment of the invention is shown on FIG. 1, which depicts a passenger protection device 1. The passenger protection device 1 is arranged in a steering wheel 2, and designed to be integrated into a vehicle, in particular a car. The passenger protection device 1 encompasses an airbag module 3 arranged in a hub area 4 of the steering wheel 2. The airbag module 3 is preferably designed as a driver's side and/or front airbag. The airbag module 3 encompasses an airbag, a gas generator and an airbag module cover 5.

The airbag module cover 5 has a weakened area 6. The weakened area 6 takes the form of a weakened line, and is suitable and/or designed for providing an opening function given an activation of the airbag module 3, e.g., during a vehicle collision. The airbag module cover 5 preferably opens in the weakened area 6 when parts and/or areas of the airbag module cover 5 are folded away and/or over and/or tear open. In particular, the weakened area 6 allows the airbag to deploy completely through the weakened area 6 toward the driver of the vehicle. The weakened area 6 is situate din the central area of the airbag module covering 5. It is linear, and after curving in two directions (see arrows A and B), runs straight. In particular, the weakened area forms a weakened line that after the curve progresses along a straight path, and is situated along a central line C of the airbag module cover 5. The weakened area 6 subsequently extends along an arc, along an upper end (see arrow A) and a lower end (see arrow B) of a partial area 7b of the airbag module cover 5, and ends at the lateral limits of the partial area 7b.

The airbag module 3, in particular the airbag module cover 5, has a covering 7, which is divided into two covering sections 7a; 7b. The covering sections 7a; 7b have edge areas 8 that are aligned to follow the progression of the weakened areas 6. In particular, the edge areas run parallel to the weakened area 6. The edge areas 8 each form an edge in the weakened area 6, and/or are optically embossed in the weakened area 6.

The covering section 7a is designed as a textile. The textile forms a sheet-like fabric, and takes the form of a woven and/or knitted fabric. The textile preferably encompasses a material comprised of natural and artificial fibers, in particular a cotton/polyester mixture. The covering section 7a or textile has holes, in particular is designed as a grid.

The covering section 7b is designed as a flexible film with a thickness of up to 1 mm, in particular up to approximately 0.5 mm. The film preferably consists of plastic or metal.

As an alternative, the covering section 7a and/or 7b can also encompass leather or pelt, wherein both natural and artificial leather and/or natural and artificial felt can be used. It is also conceivable that the airbag module cover 5 in this section not be covered with the covering. The covering section that is not covered can optionally be painted or have a dyed material.

The covering 7 has two surface-finishing elements 9. The first surface-finishing element 9 is designed as an “airbag” logo, and stitched into the covering section 7a or the textile. The surface-covering element 9 encompasses fluorescent fibers, which optically radiate when stimulated. The second surface-covering element 9 encompasses an embossed area in the form of the Opel brand symbol, a round emblem showing a thunderbolt. The embossed area is suitable for imparting a three-dimensional structure to the covering section 7b or metal film. The surface-covering elements 9 are used as information media, in that they allude to the integrated airbag module 3 and show the brand name of a motor vehicle manufacturer.

The covering 7 has a protective layer that is able to avoid optical, haptic and/or qualitative damage to the covering 7. In particular, the protective layer is designed to prevent fading, contamination and/or yellowing of the covering 7, or enable easy cleaning of the covering 7. The protective layer preferably encompasses an impregnation and/or Nano, Top Tec, Teflon and/o paint coating.

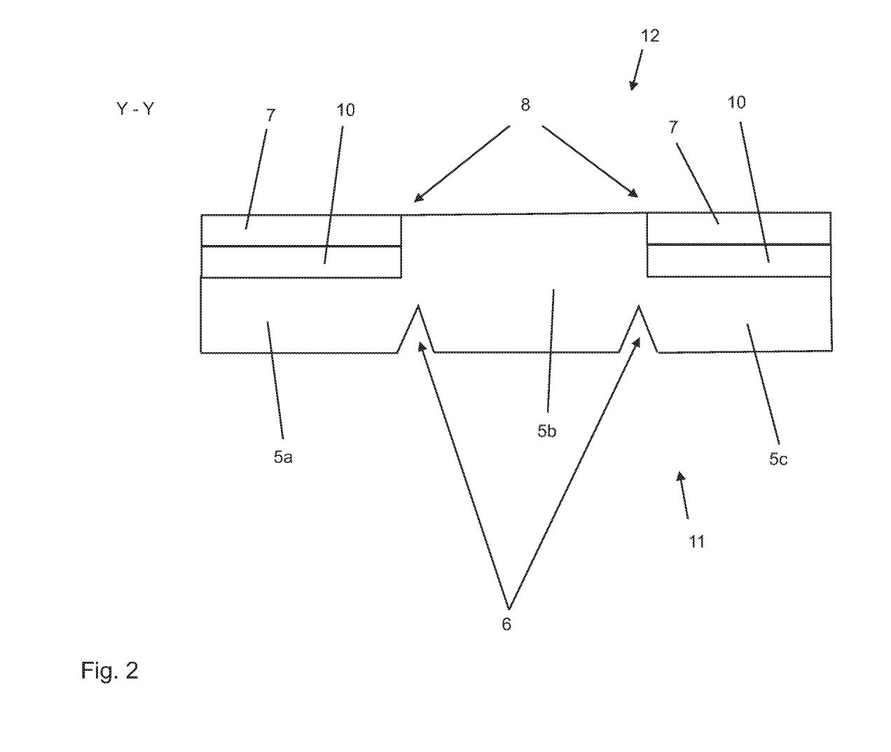

FIG. 2 shows a section through a variant of the passenger protection device 1, in particular through a variant of the airbag module 3 from FIG. 1. Corresponding or identical parts in the figures are each provided with the same reference numbers.

The airbag module cover 5 encompasses three areas 5a, 5b and 5c. Areas 5a and 5c have the covering 7. Area 5b is not covered with the covering 7. The airbag module cover 5 is reduced by the thickness of the covering 7 in areas 5a and 5c to create a smooth transition to area 5b. The covering 7 has an intermediate layer 10, wherein the covering 7 is adhesively secured to the intermediate layer 10. The intermediate layer 10 is designed as an adhesive layer. The adhesive layer holds the covering on the areas 5a and 5c of the airbag module cover 5 in a flush manner.

As an alternative, the intermediate layer 10 can be designed as a carrier film or composite material, which is joined with the airbag module cover 5 through back injection or a welding process.

The weakened area 6 is exclusively arranged on a bottom side 11 of the airbag module cover 5, wherein the bottom side 11 is a side of the airbag module cover 5 situated in a direction facing away from a vehicle passenger compartment. The weakened area 6 is not visible from the vehicle passenger compartment, and not arranged in an area perceptible to the driver of the vehicle.

Areas 5a and 5b and areas 5c and 5b are separated from each other on the bottom side 11 by the weakened area 6, and on the upper side 12 by the edge areas of the covering 7.

Areas 5a and 5c are designed as moving flaps, which open and move away laterally when the airbag module 3 is activated in the weakened area 6 to allow the inflating airbag to exit the airbag module 3.

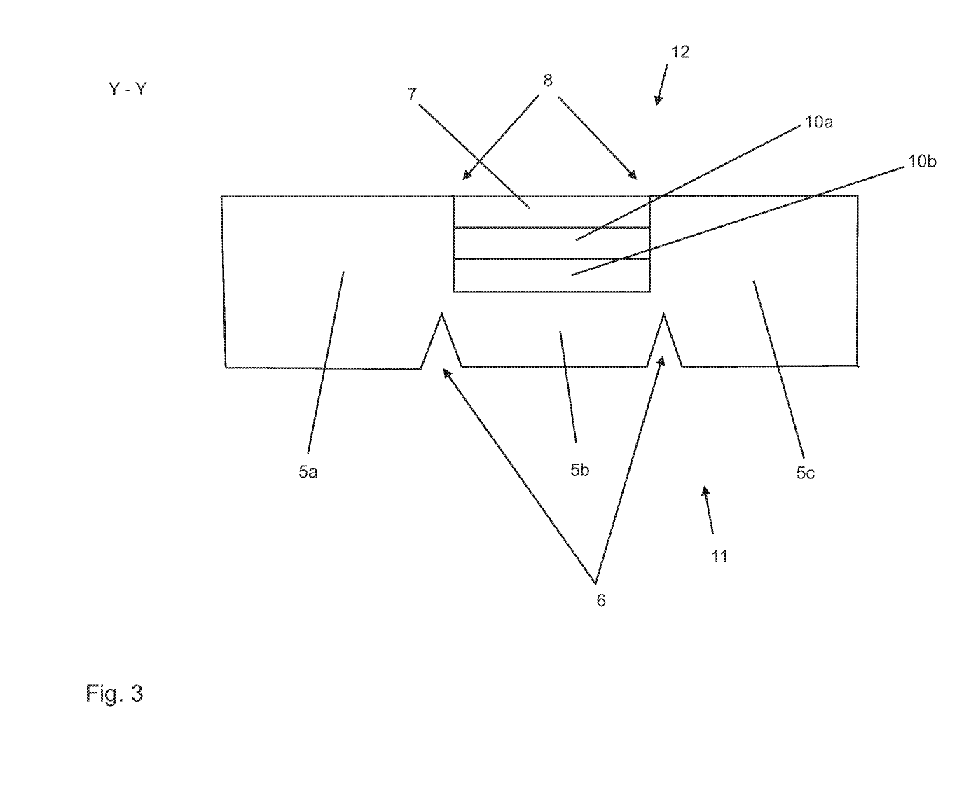

FIG. 3 shows a section through another modification of the passenger protection device 1 or airbag module 3 from FIG. 1. Corresponding or identical parts in the figures are each provided with the same reference numbers.

Areas 5a and 5c of the airbag module cover 5 have no covering 7. By contrast, area 5b is covered by a covering 7 having two intermediate layers 10a; 10b. Area 5b is reduced by the thickness of the covering 7 to create a smooth transition to areas 5a and 5c.

The intermediate layer 10a is designed as a carrier layer, e.g., a barrier layer or composite material. The carrier layer is secured to the airbag module cover 5 via the intermediate layer 10b, wherein the intermediate layer 10b is designed as an adhesive layer.

Areas 5a and 5c are statically and/or immovably arranged, while area 5b is moveably designed, and allows the airbag to exit from the airbag module 3 during an accident by moving away from the airbag module cover 5.

While at least one exemplary embodiment has been presented in the foregoing summary and detailed description, it should be appreciated that a vast number of variations exist. It should also be appreciated that the exemplary embodiment or exemplary embodiments are only examples, and are not intended to limit the scope, applicability, or configuration in any way. Rather, the foregoing summary and detailed description will provide those skilled in the art with a convenient road map for implementing an exemplary embodiment, it being understood that various changes may be made in the function and arrangement of elements described in an exemplary embodiment without departing from the scope as set forth in the appended claims and their legal equivalents.

What is claimed is:

1. A passenger protection device for a vehicle, comprising:
an airbag module that encompasses an airbag module cover;
a weakened area of the airbag module cover is adapted to provide an opening function for the airbag module upon activation of the airbag module;
a covering of the airbag module comprising an edge area that follows a substantially similar progression as the weakened area.

2. The passenger protection device according to claim 1, wherein the covering is optically embossed in the weakened area.

3. The passenger protection device according to claim 1, wherein the weakened area is situated exclusively on a bottom side of the airbag module cover and the bottom side is a side of the airbag module cover that is arranged in a direction facing the airbag module.

4. The passenger protection device according to claim 1, wherein the covering comprises a textile.

5. The passenger protection device according to claim 1, wherein the covering comprises a leather.

6. The passenger protection device according to claim 1, wherein the covering comprises a pelt.

7. The passenger protection device according to claim 1, wherein the covering comprises a film.

8. The passenger protection device according to claim 1, wherein the covering is substantially continuously formed with respect to edge areas.

9. The passenger protection device according to claim 1, wherein the covering comprises at least one intermediate layer.

10. The passenger protection device according to claim 1, wherein the covering joined with the airbag module in a flush manner.

11. The passenger protection device according to claim 1, wherein the covering is joined with the airbag module through back injection molding.

12. The passenger protection device according to claim 1, wherein the covering comprises a surface-finishing element.

13. The passenger protection device according to claim 12, wherein the surface-finishing element comprises an embossed area.

14. The passenger protection device according to claim 12, wherein the surface-finishing element comprises a patch.

15. The passenger protection device according to claim 1 wherein the covering is adapted to protect the covering.

16. A method for manufacturing an airbag module that encompasses an airbag module cover, a weakened area of the airbag module cover is adapted to provide an opening function for the airbag module upon activation of the airbag module and a covering of the airbag module comprises an edge area that follows a substantially similar progression as the weakened area, the method comprising the steps of:
coating the airbag module cover with at least one intermediate layer; and
joining the airbag module cover and the at least one intermediate layer with the airbag module in a substantially flush manner.
